(19) United States
(12) Patent Application Publication
(10) Pub. No.: US 2014/0111405 A1
(43) Pub. Date: Apr. 24, 2014

(54) GAMMA SETTING PATTERN OF ORGANIC LIGHT EMITTING DISPLAY DEVICE AND GAMMA SETTING METHOD USING THE SAME

(71) Applicant: SAMSUNG DISPLAY CO., LTD., Yongin-City (KR)

(72) Inventors: Hee-Seong JEONG, Yongin-City (KR); Hyun-Shik LEE, Yongin-City (KR)

(73) Assignee: SAMSUNG DISPLAY CO., LTD., Yongin-City (KR)

(21) Appl. No.: 13/762,530

(22) Filed: Feb. 8, 2013

(30) Foreign Application Priority Data
Oct. 22, 2012 (KR) 10-2012-0117539

(51) Int. Cl. G09G 3/20

(52) U.S. Cl. CPC G09G 3/2003
USPC 345/77

(57) ABSTRACT

A gamma setting pattern of an organic light emitting display device and a gamma setting method using the same, which can be applied to even a small screen and improve accuracy of gamma setting. The gamma setting pattern includes a grayscale display region and a circumference pattern. The grayscale display region is disposed at the center of a screen, and emits light corresponding to one of a plurality of predetermined grayscale values for setting a gamma value. The circumference pattern is disposed at the circumference of the grayscale display region, and has luminance varied corresponding to the grayscale displayed in the grayscale display region and a predetermined panel current amount.

### CLAIM PRIORITY

This application makes reference to, incorporates the same herein, and claims all benefits accruing under 35 U.S.C. §119 from an application earlier filed in the Korean Intellectual Property Office on 22 Oct. 2012 and there duly assigned Serial No. 10-2012-0117539.

### BACKGROUND OF THE INVENTION

1. Field of the Invention

An aspect of the present invention relates to a gamma setting pattern of an organic light emitting display device and a gamma setting method using the same.

2. Description of the Related Art

An organic light emitting display device that is one of flat panel display devices displays images using organic light emitting diodes that emit light through recombination of electrons and holes. The organic light emitting display device uses a self-luminescent element, and hence does not require a separate light source. Thus, the organic light emitting display device is advantageous to obtain thin thickness and light weight, and is suitable for implementing a flexible display device. Further, the organic light emitting display device has a fast response speed and is driven with low power consumption.

The above information disclosed in this Related Art section is only for enhancement of understanding of the background of the invention and therefore it may contain information that does not form the prior art that is already known to a person of ordinary skill in the art.

### SUMMARY OF THE INVENTION

Embodiments provide a gamma setting pattern of an organic light emitting display device and a gamma setting method using the same, which can be applied to even a small screen and improve accuracy of gamma setting.

According to an aspect of the present invention, there may be provided a gamma setting pattern of an organic light emitting display device, including: a grayscale display region disposed at the center of a screen, and emitting light corresponding to one of a plurality of predetermined grayscale values for setting a gamma value; and a circumference pattern disposed at the circumference of the grayscale display region, and having luminance varied corresponding to the grayscale displayed in the grayscale display region and a predetermined panel current amount.

The luminance of the circumference pattern may be adjusted so that the amount of current flowing in the screen including the grayscale display region and the circumference pattern is within a range of the panel current amount.

The luminance of the circumference pattern may be set to be decreased as the grayscale displayed in the grayscale display region may be a grayscale corresponding to high luminance.

The grayscale display region may be set to have a rectangular shape, and the circumference pattern may be disposed along the circumference of the rectangular pattern so that the screen may be implemented in a frame shape.

According to an aspect of the present invention, there may be provided a gamma setting method of an organic light emitting display device, including: sequentially displaying grayscales respectively corresponding to a plurality of predetermined grayscale values on a screen of the organic emitting display device; and setting a gamma value by detecting the luminance of a region in which each grayscale may be displayed, wherein a grayscale corresponding to one of the plurality of grayscale values is displayed in a grayscale display region disposed at the center of the screen, and the luminance of a circumference pattern disposed at the circumference of the grayscale display region may be varied corresponding to a predetermined panel current amount.

The luminance of the circumference pattern may be adjusted so that the amount of current flowing in the screen including the grayscale display region and the circumference pattern may be within a range of the panel current amount.

The luminance of the circumference pattern may be set to be decreased as the grayscale displayed in the grayscale display region may be a grayscale corresponding to high luminance.

As described above, in the gamma setting pattern of the organic light emitting display device and the gamma setting method using the same according to the present invention, the blurring phenomenon occurring between the low grayscale and the black grayscale is improved, and the distortion of a gamma value is prevented, so that it is possible to enhance color accuracy, thereby improving accuracy in gamma setting.

Further, it is possible to display a grayscale even on a small screen and to sufficiently secure a region for measuring luminance, chromaticity, etc. Furthermore, since it is unnecessary to move a device such as a luminance system for each region in which each grayscale is displayed, the tact time can be decreased.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a plan view showing gamma setting screens of comparative examples 1 and 2.

FIG. 2 shows a gamma setting screen of the present invention, which is a plan view showing a gamma setting screen on which a gamma setting pattern is displayed according to an embodiment of the present invention.

FIG. 3 is a plan view showing an example of grayscales sequentially displayed on the gamma setting pattern in gamma setting using the gamma setting pattern shown in FIG. 2.

FIG. 4 is a graph showing luminance ratios for each grayscale, measured in gamma setting according to the comparative example 1 and the present invention.

### DETAILED DESCRIPTION OF THE INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Hereinafter, like reference numerals refer to like elements.

It will be understood that, although the terms first, second, third etc. may be used herein to describe various elements, components, regions, layers, patterns and/or sections, these elements, components, regions, layers, patterns and/or sections should not be limited by these terms. These terms are only used to distinguish one element, component, region, layer pattern or section from another region, layer, pattern or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross sectional illustrations that are schematic illustrations of illustratively idealized example embodiments (and intermediate structures) of the inventive concept. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. The regions illustrated in the figures are schematic in nature and their shapes are not intended to illustrate the actual shape of a region of a device and are not intended to limit the scope of the inventive concept.

Unless otherwise defined, all term's (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein

In a display a gamma value should be set in consideration of characteristics of display devices in order to control the display devices to display a desired luminance, etc. The setting of the gamma value can be performed by setting the gamma value so that a desired luminance value can be obtained after a predetermined gray scale is displayed on a display panel.

To this end, in the organic light emitting display device, the gamma value can be set by sequentially displaying the predetermined grayscale with respect to the entire screen of the display panel or by displaying a plurality of grayscales in a gradated strip shape on one screen. In this case, there may occur a problem in that a distortion phenomenon for each grayscale is caused by a voltage drop (IR-drop), it is difficult to apply the organic light emitting display device to a small screen, etc.

Hereinafter, exemplary embodiments of the present invention will be described in detail with reference to the accompanying drawings.

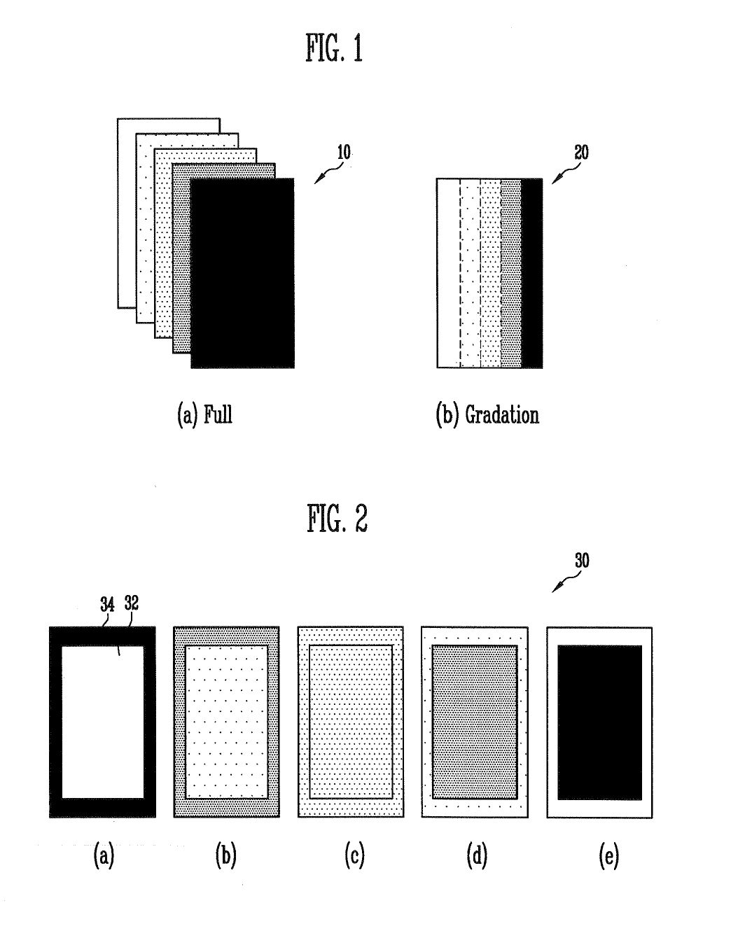

FIG. 1 is a plan view showing gamma setting screens of comparative examples 1 and 2. Here, FIG. 1(a) shows a gamma setting screen of the comparative example 1, and FIG. 1(b) shows a gamma setting screen of the comparative example 2.

Referring to FIG. 1, in the comparative example 1 shown in FIG. 1(a), grayscales respectively corresponding to a plurality of predetermined grayscale values may be sequentially displayed with respect to the whole screens 10 of a display panel, and a gamma value may be set so that a desired luminance value can be obtained by detecting and analyzing characteristics such as luminance when each grayscale is displayed.

Alternatively, in the comparative example 2 shown in FIG. 1(b), a plurality of grayscales may be displayed in a gradated strip shape on one screen 20, and a gamma value may be set by detecting and analyzing characteristics such as luminance in a region in which each grayscale is displayed.

In the comparative example 1 shown in FIG. 1(a), the gamma setting screen can be easily applied to even a small screen. Further, since it is unnecessary to move a device for measurement, such as a luminance system, tact time can be decreased.

However, in a case where the comparative example 1 is applied to an organic light emitting display device, a distortion phenomenon for each grayscale, caused by a voltage drop (IR drop) may occur due to a characteristic of the organic light emitting display device, in which the voltage drop is changed depending on the amount of current flowing in a display panel. For example, there may occur a distortion phenomenon that luminance decreases in a low grayscale region in which the amount of current flowing in the display panel is relatively small.

In this case, it is difficult to distinguish a low grayscale from a black grayscale, and therefore, a blurring phenomenon may occur between the low grayscale and the black grayscale.

In the comparative example 2 shown in FIG. 1(b), the distortion phenomenon for each grayscale or degradation of color accuracy is prevented. However, when considering conditions of a device such as a luminance system, it is difficult to apply the gamma setting screen to a small screen. Further, optical characteristics should be measured by moving the device such as the luminance system for each region, and therefore, the tact time increases.

Accordingly, the present invention discloses a gamma setting pattern of an organic light emitting display device and a gamma setting method using the same, which can be applied to even a small screen and improve accuracy of gamma setting. Hereinafter, a gamma setting pattern of an organic light emitting display device and a gamma setting method using the same according to an embodiment of the present invention will be described in detail with reference to FIGS. 2 to 4.

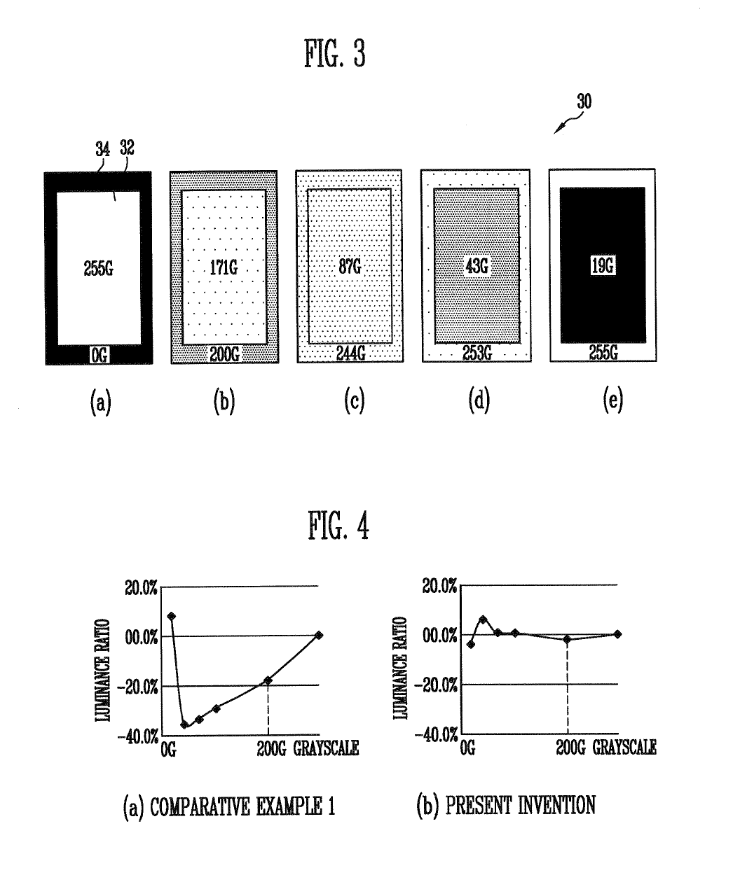

FIG. 2 shows a gamma setting screen of the present invention. Particularly, FIG. 2 is a plan view showing a gamma setting screen on which a gamma setting pattern is displayed according to an embodiment of the present invention. FIG. 3 is a plan view showing an example of grayscales sequentially displayed on the gamma setting pattern in gamma setting using the gamma setting pattern shown in FIG. 2.

Referring to FIG. 2, the gamma setting pattern according to this embodiment includes a grayscale display region 32 which may be disposed at the center of a screen 30 and emits light corresponding to one of a plurality of predetermined grayscale values for setting a gamma value, and a circumference pattern 34 which may be disposed at the circumference of the grayscale display region 32 and has luminance varied corresponding to the grayscale displayed in the grayscale display region 32 and a predetermined panel current amount.

Here, the shape of each of the grayscale display region 32 and the circumference pattern 34 is not necessarily limited to any one shape. For example, in this embodiment, the grayscale display region 32 may be set to have a rectangular shape disposed at the center of the screen 30, and the circumference pattern 34 may be disposed along the circumference of the rectangular pattern, so that the screen 30 may be entirely implemented in a frame shape. If the gamma setting pattern may be set to have a simple shape that is effective in embodying the present invention, it is easy to implement and measure the screen when a gamma voltage is set.

The gamma setting pattern of the present invention is used to equally maintain the entire amount of current flowing in the display panel, regardless of a grayscale displayed for the purpose of gamma setting. Here, the term “equally” comprehensively means not only that values substantially correspond to one another but also that the values are maintained as similar values within a predetermined error range.

That is, in the present invention, the luminance of the circumference pattern 34 may be adjusted so that the amount of current flowing in the screen 30 including the grayscale display region 32 and the circumference pattern 34 may be a predetermined panel current amount or within its range.

To this end, the luminance of the circumference pattern 34 may be set to be decreased as the grayscale displayed in the grayscale display region 32 may be a grayscale corresponding to high luminance. On the contrary, the luminance of the circumference pattern 34 may be set to be increased as the grayscale displayed in the grayscale display region 32 may be a grayscale corresponding to low luminance. That is, while the luminance 32 of the grayscale display region 32 is decreased from FIG. 2 (a) to (e), the luminance of the circumference pattern 34 is increased from FIG. 2 (a) to (e).

For example, as shown in FIG. 3, when the grayscale display region 32 displays 171G, 87G, 43G and 19G while gradually getting dark from 255G of the brightness white grayscale, the grayscale displayed in the circumference pattern 34 may display 200G, 244G 253G and 255G while gradually getting bright from OG of the darkest black grayscale.

However, the grayscale displayed in FIG. 3 shows an example for embodying the present invention, and it will be apparent that the grayscale displayed in the circumference pattern 34 corresponding to the grayscale displayed in the grayscale display region 32 may be changed depending on a predetermined panel current amount and its area ratio.

For example, the area of the grayscale display region 32 may be set to 30% to 50% of the area of the screen 30, which may be changed depending on a measuring device and an actual size of the screen 30, etc. More specifically, if the area of the grayscale display region 32 is small, it is advantageous to improve accuracy in gamma setting, but the area of the grayscale display region 32 may get out of measurement limitation. Therefore, the area of the grayscale display region 32 may be modified in consideration of current measurement conditions.

The panel current amount may also be set in consideration of conditions of the display panel in which the gamma value is to be set, etc. For example, it is assumed that one region may be set as the grayscale display region 32 and the other region may be set as the circumference region 34 by computing the minimum area which can be measured by the measurement area in consideration of conditions of the measurement device and the size of the screen 30. When the grayscale display region 32 displays the brightest white grayscale and the circumference pattern 34 displays the darkest black grayscale, the amount of current flowing in the display panel may be set to the panel current amount that becomes a reference in the gamma setting.

In the gamma setting method of the organic light emitting display device using the gamma setting pattern according to this embodiment, grayscales respectively corresponding to a plurality of predetermined grayscale values are sequentially displayed on the screen 30, and the gamma value may be set by detecting the luminance of a region in which each grayscale is displayed, etc. In this case, a grayscale corresponding to one of the plurality of grayscale values may be displayed in the grayscale display region 32, and the luminance of the circumference pattern 34 may be varied corresponding to the grayscale and a predetermined panel current amount. Thus, the luminance of the screen 30 can be adjusted so that the amount of current flowing in the entire current 30 may be within a range of the predetermined panel current amount. Accordingly, it is possible to prevent the occurrence of a distortion phenomenon for each grayscale due to different degrees of voltage drop.

According to the gamma setting pattern and the gamma setting method using the same of the present invention, the blurring phenomenon occurring between the low grayscale and the black grayscale is improved, and the distortion of a gamma value is prevented, so that it is possible to enhance color accuracy, thereby improving accuracy in gamma setting. For example, in the comparative example 1, the gamma value in the gamma setting is set to about 2.4. However, in the present invention, the gamma value in the gamma setting is set to about 2.2 that is similar to the gamma value set when a plurality of grayscales are displayed in a stripe shape on one screen.

Since a plurality of grayscales to be displayed for the purpose of setting a gamma value are all displayed on one screen, it is possible to display a grayscale even on a small screen and to sufficiently secure a region (grayscale display region) for measuring luminance, chromaticity, etc. Further, since it is unnecessary to move a device such as a luminance system for each region in which each grayscale is displayed, the tact time can be decreased.

FIG. 4 is a graph showing luminance ratios for each grayscale, measured in gamma setting according to the comparative example 1 and the present invention, which shows a result of a comparative experimental example. Here, the luminance ratio refers to a ratio an actually measured luminance value and a standard luminance value.

Referring to FIG. 4, in case of the comparative example 1 in which the gamma value is set by sequentially displaying the grayscales respectively corresponding to the plurality of predetermined grayscale values, the distortion phenomenon for each grayscale occurs due to different degrees of voltage drop. That is, in a case where the gamma value is set as shown in the comparative example 1, it can be seen that the luminance difference between grayscales is large. Particularly, it can be seen that the error rate in a low grayscale region is large.

On the other hand, it can be seen that when the gamma value is set using the gamma setting pattern according to the present invention, the luminance difference between grayscales is considerably improved.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A gamma setting pattern of an organic light emitting display device, comprising:
a grayscale display region disposed at a center of a screen, and emitting light corresponding to one of a plurality of predetermined grayscale values for setting a gamma value; and
a circumference pattern disposed at the circumference of the grayscale display region, and having luminance varied corresponding to the grayscale displayed in the grayscale display region and a predetermined panel current amount.

2. The gamma setting pattern according to claim 1, wherein the luminance of the circumference pattern is adjusted so that the amount of current flowing in the screen including the grayscale display region and the circumference pattern is within a range of the panel current amount.

3. The gamma setting pattern according to claim 1, wherein the luminance of the circumference pattern is set to be decreased as the grayscale displayed in the grayscale display region is a grayscale corresponding to high luminance.

4. The gamma setting pattern according to claim 1, wherein the grayscale display region is set to have a rectangular shape, and the circumference pattern is disposed along the circumference of the rectangular pattern so that the screen is implemented in a frame shape.

5. The gamma setting pattern according to claim 1, wherein the area of the grayscale region is set to 30% to 50% of the area of the screen.

6. A gamma setting method of an organic light emitting display device, comprising:
sequentially displaying grayscales respectively corresponding to a plurality of predetermined grayscale values on a screen of the organic emitting display device; and
setting a gamma value by detecting the luminance of a region in which each grayscale is displayed,
wherein a grayscale corresponding to one of the plurality of grayscale values is display in a grayscale display region disposed at a center of the screen, and the luminance of a circumference pattern disposed at the circumference of the grayscale display region is varied corresponding to a predetermined panel current amount.

7. The gamma setting method according to claim 6, wherein the luminance of the circumference pattern is adjusted so that the amount of current flowing in the screen including the grayscale display region and the circumference pattern is within a range of the panel current amount.

8. The gamma setting method according to claim 6, wherein the luminance of the circumference pattern is set to be decreased as the grayscale displayed in the grayscale display region is a grayscale corresponding to high luminance.

9. The gamma setting pattern according to claim 1, wherein the circumference pattern entirely surrounds the grayscale display region.

10. The gamma setting pattern according to claim 6, wherein the circumference pattern entirely surrounds the grayscale display region.
